(19) United States
(12) Patent Application Publication
(10) Pub. No.: US 2025/0341719 A1
(43) Pub. Date: Nov. 6, 2025

(54) WAVEGUIDE WITH HYBRID OUTCOUPLER AND EXIT PUPIL EXPANDER REGION

(71) Applicant: GOOGLE LLC, Mountain View, CA (US)

(72) Inventors: Ravi Kumar Komanduri, Milpitas, CA (US); Qinglan Huang, Mountain View, CA (US); Joseph Daniel Lowney, Tucson, AZ (US)

(21) Appl. No.: 18/654,468

(22) Filed: May 3, 2024

(51) Int. Cl. G02B 27/01

(52) U.S. Cl. CPC G02B 27/0172; G02B 2027/0123; G02B 2027/0178

(57) ABSTRACT

A waveguide includes an incoupler to incouple light beams into the waveguide, an exit pupil expander to receive a first portion of the incoupled light beams and redirect the first portion of the incoupled light beams to an outcoupler, and an outcoupler to receive the redirected first portion of the incoupled light beams and outcouple the redirected first portion of the incoupled light beams from the waveguide. The outcoupler includes a section that receives a second portion of the incoupled light beams and redirects the second portion of the incoupled light beams to the exit pupil expander, and the exit pupil expander includes a section that receives the redirected second portion of the incoupled light beams and outcouples the redirected second portion of the incoupled light beams from the waveguide.

### BACKGROUND

In some extended reality (XR) eyewear displays such as augmented reality (AR) or virtual reality (VR) eyewear displays, display light beams emitted from an image source are coupled into a waveguide by an incoupler which can be formed as an optical grating on a surface of the waveguide. Once the display light beams have been coupled into the waveguide, the incoupled display light beams are “guided” through the waveguide, typically by multiple instances of total internal reflection (TIR), expanded in at least one direction by an exit pupil expander, and then directed out of the waveguide by an outcoupler, which can also be formed as an optical grating on a surface of the waveguide. The outcoupled display light beams overlap at an eye relief distance from the waveguide forming an exit pupil within which a virtual image generated by the image source can be viewed by the user of the eyewear display.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of an eyewear display in accordance with some embodiments.

FIG. 2 shows an example of a projection system in the eyewear display of FIG. 1 in accordance with some embodiments.

FIG. 3 shows an example of light propagation from an image source to a user of an eyewear display, such as that of FIGS. 1 and 2, in accordance with some embodiments.

FIG. 4 shows an example of light propagation within a waveguide, such as the waveguide of FIGS. 2 and 3, in accordance with some embodiments.

FIGS. 5A, 5B and FIGS. 6A, 6B illustrate problems associated with conventional waveguides.

FIG. 7 shows a waveguide having a hybrid outcoupler and exit pupil expander region, an extended exit pupil expander zone, and a recycler region in accordance with some embodiments.

FIGS. 8A, 8B and FIGS. 9A, 9B show close up views of the hybrid outcoupler and exit pupil expander region of the waveguide of FIG. 7 and corresponding k-space vector diagrams in accordance with some embodiments.

FIGS. 10A, 10B show close up views of an alternative configuration of the hybrid outcoupler and exit pupil expander region of the waveguide of FIG. 7 having interlaced regions in accordance with some embodiments.

FIG. 11 shows an example of the additional light spreading provided by the extended exit pupil expander zone of the waveguide in FIG. 7 in accordance with some embodiments.

FIGS. 12A, 12B show an example of the recycling of light by the recycler region of the waveguide in FIG. 7 and a corresponding k-space vector diagram in accordance with some embodiments.

FIG. 13 shows an example of a cross-section of a portion of a grating structure of any one of the incoupler, the exit pupil expander, the outcoupler, or the recycler region of the waveguide of FIGS. 2-4 and 7-12 in accordance with some embodiments.

FIG. 14 shows an example flowchart illustrating a method for directing light within a waveguide in accordance with some embodiments.

### DETAILED DESCRIPTION

Waveguides in eyewear displays are designed to deliver high quality virtual content to the user within volume constraints imposed by the form factor of the eyewear display and the weight constraints imposed by user comfort requirements. In addition, in some cases, the design of the waveguide is based on other factors such as aesthetics (e.g., so that the eyewear display looks socially acceptable) and reducing the effect that the waveguide has on ambient light from the environment to name a few. Waveguides are typically made of multiple glass or plastic substrates with optical gratings which form one or more of the incoupler, the exit pupil expander, and the outcoupler. These optical gratings are collectively designed to optimize display attributes such as brightness, color uniformity, and image sharpness within a target eyebox of the eyewear display, where the eyebox is defined as a volume in which a user of the eyewear display can observe the virtual content. However, the positioning of the incoupler, exit pupil expander, and the outcoupler, as well as the respective spaces that they occupy within the waveguide, are constrained by the space that is available within the waveguide. For example, the area occupied by one (or both) of the exit pupil expander and the outcoupler is typically restricted to allow for the area occupied by the other. Limiting the size of one or both of the exit pupil expander and the outcoupler reduces the size of the eyebox of the eyewear display and may also affect the quality of the virtual content delivered to the user.

The present disclosure provides a waveguide architecture that improves display attributes such as color uniformity and brightness by making more effective use of the available space within the waveguide compared to conventional waveguides. In some embodiments, the waveguide architecture disclosed herein includes a hybrid outcoupler and exit pupil expander region that increases the amount of display light that is propagated from the image source to the user, thereby improving performance of the eyewear display. In addition, some embodiments include one or more of: an expanded exit pupil expander region so that the region covers area relatively high amount of area within the waveguide compared to conventional waveguide architectures and a recycler region on an opposite side of the outcoupler as the exit pupil expander region to redirect light back toward the outcoupler to improve the overall efficiency of the waveguide.

To illustrate, in some embodiments, an eyewear display includes a waveguide arranged in at least one lens of the eyewear display. The waveguide includes an incoupler to incouple light beams into the waveguide, an exit pupil expander to receive a first portion of the incoupled light beams and redirect the first portion of the incoupled light beams to an outcoupler, and an outcoupler to receive the redirected first portion of the incoupled light beams and outcouple the redirected first portion of the incoupled light beams from the waveguide. In addition, the outcoupler receives a second portion of the incoupled light beams and redirects the second portion of the incoupled light beams to the exit pupil expander, and the exit pupil expander receives the redirected second portion of the incoupled light beams and outcouples the redirected second portion of the incoupled light beams from the waveguide. Thus, each one of the outcoupler and the exit pupil expander includes a corresponding section that is designed with a “hybrid” functionality in that it outcouples display light received from the other section and propagates incoupled light to the other section for outcoupling. That is, a first section in the exit pupil expander is configured to receive incoupled display light and direct it to a second section in the outcoupler for outcoupling from the waveguide. In addition, the second section of the outcoupler is configured to receive incoupled display light and direct it to the first section of the exit pupil expander for outcoupling from the waveguide. This improves the brightness and color uniformity of the display light that is outcoupled from the waveguide, thereby improving the quality of the virtual content across the eyebox of the eyewear display.

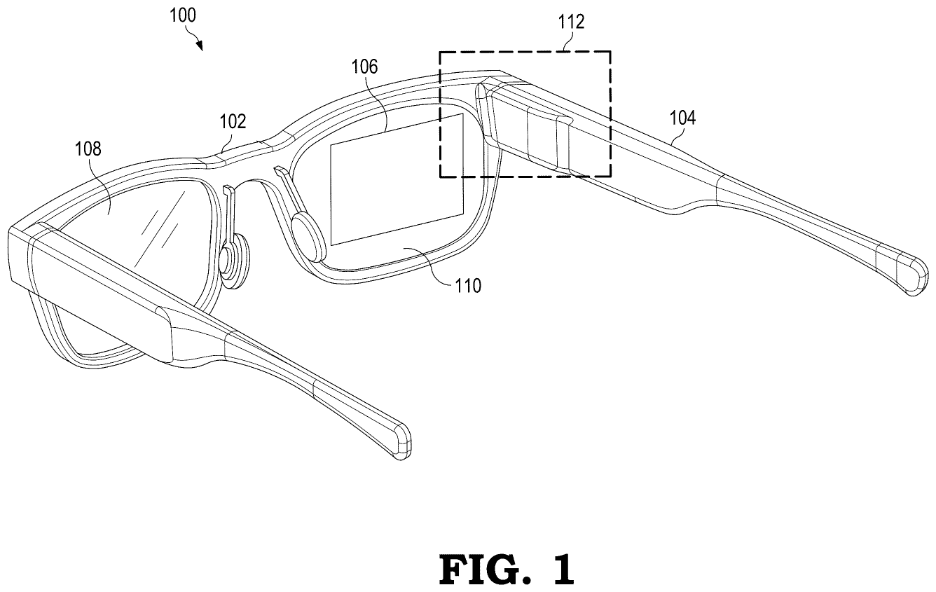

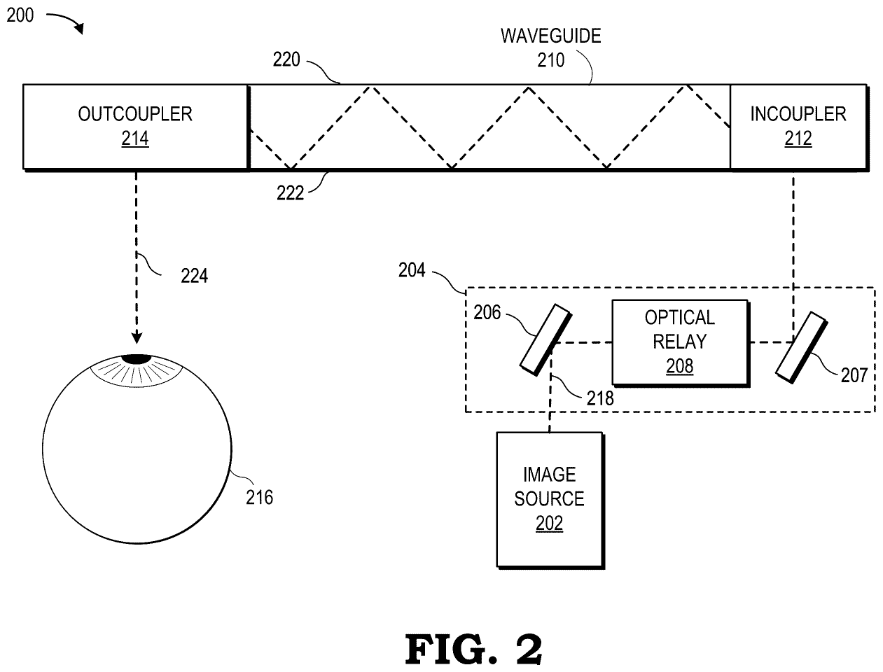

FIG. 1 illustrates an example eyewear display 100 in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images towards the eye of a user, such that the user perceives the projected images as being displayed in a field of view (FOV) 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images towards the eye of the user, such as an image source, a light engine assembly (LEA) including one or more lenses, prisms, mirrors, or other optical components, and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in region 112 of the support structure 102. It should be noted that while an example form factor is depicted, it will be appreciated that in other embodiments the eyewear display 100 may have a different shape and appearance from the eyeglasses frame depicted in FIG. 1.

In some embodiments, one or both of the lens elements 108, 110 are used by the eyewear display 100 to provide a mixed reality (MR) or an augmented reality (AR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from an image source in the eyewear display 100. For example, light used to form a perceptible image or series of images may be projected by the image source of the eyewear display 100 onto the eye of the user via a series of optical elements, such as a waveguide formed at least partially in the corresponding lens element, a LEA including one or more light filters, lenses, scan mirrors, optical relays, prisms, or the like. In some embodiments, the image source is configured to emit light having a plurality of wavelength ranges, e.g., red light, green light, and blue light (collectively referred to as RGB light). The LEA propagates the light toward an incoupler of the waveguide. The incoupler of the waveguide receives this light and incouples it into the waveguide. One or both of the lens elements 108, 110 thus includes at least a portion of a waveguide that routes display light received by the incoupler of the waveguide to an outcoupler of the waveguide, which outputs the display light towards an eye of a user of the eyewear display 100. The display light is modulated and projected onto the eye of the user such that the user perceives the display light as an image in FOV 106. In addition, in some embodiments, each of the lens elements 108, 110 is sufficiently transparent to allow a user to see through the lens elements to provide a field of view of the user's real-world environment such that the image appears superimposed over at least a portion of the real-world environment.

In some embodiments, the image source is a modulative light source such as laser projector or a display panel having one or more light-emitting diodes (LEDs) or organic light-emitting diodes (OLEDs) (e.g., a micro-LED display panel or the like) located in region 112. In some embodiments, the image source is configured to emit RGB light. The image source is communicatively coupled to the controller (not shown) and a non-transitory processor-readable storage medium or memory storing processor-executable instructions and other data that, when executed by the controller, cause the controller to control the operation of the image source. In some embodiments, the controller controls a display area size and display area location for the image source and is communicatively coupled to the image source that generates virtual content to be displayed at the eyewear display 100. In some embodiments, the image source emits light over a variable area, designated the FOV 106, of the eyewear display 100. The variable area corresponds to the size of the FOV 106, and the variable area location corresponds to a region of one of the lens elements 108, 110 at which the FOV 106 is visible to the user. Generally, it is desirable for a display to have a wide FOV 106 to accommodate the outcoupling of light across a wide range of angles.

As previously mentioned, a waveguide is integrated into one or both of lens elements 108, 110. In some configurations, the waveguide includes a single waveguide substrate and in other configurations, the waveguide includes multiple waveguide substrates stacked on top of one another (referred to as a waveguide stack). As previously discussed, the waveguide's size and shape (collectively referred to as the “form factor” of the waveguide) is restricted by the shape and volume of the lens elements 108, 110. The restriction of the waveguide's form factor restricts the positioning and the areas of the incoupler, exit pupil expander, and the outcoupler (not shown in FIG. 1) gratings in the waveguide. In conventional waveguide architectures, this results in diminished optical performance. The waveguide architecture described herein, including the aforementioned hybrid exit pupil expander and outcoupler region, improves the optical performance of the waveguide within the waveguide's restricted form factor.

FIG. 2 illustrates an example of a projection system 200 that projects images onto an eye 216 of a user in accordance with various embodiments. The projection system 200, which may be implemented in the eyewear display 100 in FIG. 1, includes one or more of an image source 202, projection optics 204, and a waveguide 210. In this example, the projection optics 204 includes a first scan mirror 206, a second scan mirror 207, and an optical relay 208. The waveguide 210 includes an incoupler 212 and an outcoupler 214, with the outcoupler 214 being optically aligned with an eye 216 of a user. For example, the outcoupler 214 substantially overlaps or corresponds with the FOV 106 shown in FIG. 1. For purposes of clarity, FIG. 2 illustrates the projection system 200 with respect to propagating display light from the image source 202 to one eye 216 of the user. In some embodiments, the projection system 200 includes a similar configuration to propagate display light from the same image source 202 to a second eye of the user (not shown in FIG. 2). That is, another waveguide (not shown in FIG. 2) is included to direct light from the image source 202 to the user's second eye.

In some embodiments, the image source 202 (such as a micro-LED display or a laser projector) includes one or more light sources configured to generate and project display light 218 (e.g., visible light such as red, blue, and green light and, in some embodiments, non-visible light such as infrared light). In some embodiments, the image source 202 is coupled to a driver or other controller (not shown), which controls the timing of emission of display light from the light sources of the image source 202 in accordance with instructions received by the controller or driver from a computer processor coupled thereto to modulate the display light 218 to be perceived as images when output to the retina of an eye 216 of a user. For example, during operation of the projection system 200, one or more beams of display light 218 are output by the light source(s) of the image source 202 and then directed into the waveguide 210 before being directed to the eye 216 of the user. The image source 202 modulates the respective intensities of the light beams so that the combined light reflects a series of pixels of an image, with the particular intensity of each light beam at any given point in time contributing to the amount of corresponding color content and brightness in the pixel being represented by the combined light at that time.

In some embodiments, the image source 202 projects the display light 218 to projection optics 204. One or both of the scan mirrors 206 and 207 of the projection optics 204 are MEMS mirrors in some embodiments. For example, the scan mirror 206 and the scan mirror 207 are MEMS mirrors that are driven by respective actuation voltages to oscillate during active operation of the projection system 200, causing the scan mirrors 206 and 207 to scan the display light 218.

In some embodiments, the optical relay 208 is a line-scan optical relay that receives the light 218 scanned in a first dimension by the first scan mirror 206, routes the light 218 to the second scan mirror 207, and introduces a convergence to the light 218 in the first dimension to an exit pupil beyond the second scan mirror 207. Herein, an “exit pupil” in an optical system refers to the location along the optical path where beams of light intersect. For example, the possible optical paths of the light 218, following reflection by the first scan mirror 206, are initially spread along a first scanning axis, but later these paths intersect at an exit pupil beyond the second scan mirror 207 due to convergence introduced by the optical relay 208. For example, the width (i.e., smallest dimension) of a given exit pupil approximately corresponds to the diameter of the light corresponding to that exit pupil. Accordingly, the exit pupil can be considered a “virtual aperture.” According to various embodiments, the optical relay 208 includes one or more collimation lenses that shape and focus the light 218 on the second scan mirror 207 or includes a molded reflective relay that includes two or more spherical, aspheric, parabolic, and/or freeform lenses that shape and direct the light 218 onto the second scan mirror 207. The second scan mirror 207 receives the display light 218 and scans the display light 218 in a second dimension, the second dimension corresponding to the long dimension of the incoupler 212 of the waveguide 210. In some embodiments, the second scan mirror 207 causes the exit pupil of the display light 218 to be swept along a line along the second dimension.

In some embodiments, the image source 202 projects the display light 218 directly to the incoupler 212. That is, in some embodiments, the projection optics 204 are absent from projection system 200. In other embodiments, the projection optics 204 are included with fewer or more optical components than those depicted in FIG. 2. For example, in some embodiments, the scan mirrors 206, 207 are absent from the projection optics 204. Accordingly, in some embodiments, the image source 202 is positioned such that the optical path of the display light 218 emitted from the image source 202 is in line with the incoupler 212.

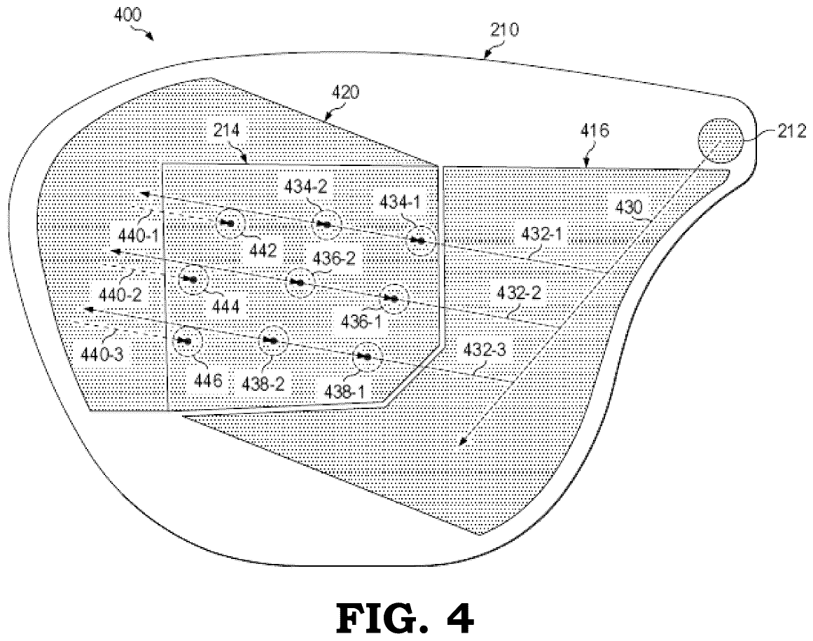

As illustrated in FIG. 2, the waveguide 210 of the projection system 200 includes the incoupler 212 and the outcoupler 214 (the waveguide also includes an exit pupil expander, which is not shown in FIG. 2 but is shown in the FIGS. 4 and 7-12). The term “waveguide,” as used herein, will be understood to mean a combiner using one or more of total internal reflection (TIR), specialized filters, or reflective surfaces, to transfer light from an incoupler (such as incoupler 212) to an outcoupler (such as the outcoupler 214). In some display applications, the light is a collimated image, and the waveguide 210 transfers and replicates the collimated image to the eye. In general, the terms “incoupler,” “exit pupil expander,” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler, exit pupil expander, or outcoupler is configured as a transmissive grating (e.g., a transmissive diffraction grating or a transmissive holographic grating) that causes the incoupler, exit pupil expander, or outcoupler to transmit light and to apply designed optical function(s) to the light during the transmission. In some embodiments, a given incoupler, exit pupil expander, or outcoupler is a reflective grating (e.g., a reflective diffraction grating or a reflective holographic grating) that causes the incoupler, exit pupil expander, or outcoupler to reflect light and to apply designed optical function(s) to the light during the reflection. In other embodiments, a given incoupler, exit pupil expander, or outcoupler includes one or more reflective mirror facets. For example, the incoupler, exit pupil expander, or the outcoupler includes a set of partially reflective mirror facets with the same or with different reflection to transmission ratios.

The incoupler 212 is configured to receive the display light 218 and direct the display light 218 into the waveguide 210. In some embodiments, the incoupler 212 is defined by a smaller dimension (i.e., width) and a larger orthogonal dimension (i.e., length) with a first edge that is in the optical path toward the outcoupler 214 and a second edge that is on the opposite side of the optical path toward the outcoupler 214. In some embodiments, the “incoupler region” is defined as the region of the waveguide 210 between the first edge and the second edge. Similarly, the “outcoupler region” is defined as the region of the waveguide occupied by the outcoupler 214. In the present example, the light 218 received at the incoupler 212 is relayed to the outcoupler 214 via the waveguide 210 using TIR. A portion of the light 218 is then output to the eye 216 of a user via the outcoupler 214. Also, in some embodiments, an exit pupil expander (not shown in FIG. 2), such as a fold or other optical grating, is arranged in an intermediate stage between incoupler 212 and outcoupler 214 to receive light that is coupled into waveguide 210 by the incoupler 212, expand the light in one dimension, and redirect the light towards the outcoupler 214, where the outcoupler 214 then couples the light out of waveguide 210. In some embodiments, the exit pupil expander and the outcoupler 214 are integrated into a common component. As described above, in some embodiments the waveguide 210 is implemented in an optical combiner as part of a lens, such as one of the lens elements 108, 110 of FIG. 1.

The waveguide 210 further includes two major surfaces 220 and 222, with major surface 220 being world-side (i.e., the surface farthest from the user) and major surface 222 being eye-side (i.e., the surface closest to the user). In some embodiments, the waveguide 210 is between a world-side lens and an eye-side lens, which form lens elements 108, 110 shown in FIG. 1, for example. In some embodiments, the incoupler 212 and the outcoupler 214 are located, at least partially, at major surface 220. In another embodiment, the incoupler 212 and the outcoupler 214 are located, at least partially, at major surface 222. In addition, in some embodiments, the exit pupil expander (not shown) is located at the same major surface 220 or 222 as the incoupler 212 and the outcoupler 214.

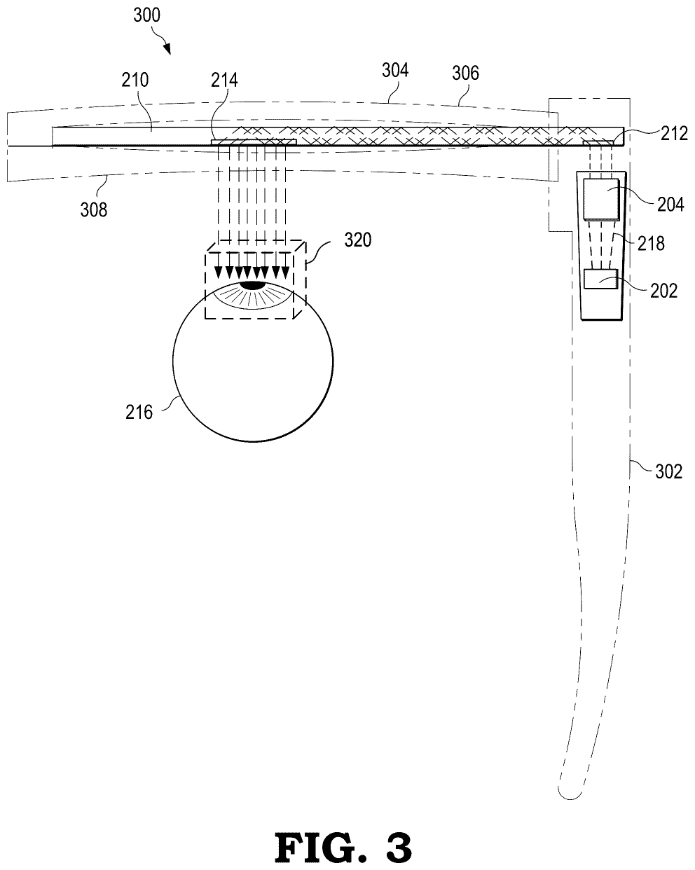

FIG. 3 illustrates a portion of an eyewear display 300 in accordance with various embodiments. In some embodiments, the eyewear display 300 represents the display 100 of FIG. 1 and includes the components of the projection system 200 of FIG. 2. The image source 202, the projection optics 204, the incoupler 212, and a portion of the waveguide 210 are included in an arm 302 of the eyewear display 300, in the present example.

The eyewear display 300 includes an optical combiner lens 304, which includes a first lens 306, a second lens 308, and the waveguide 210, with the waveguide 210 disposed between the first lens 306 and the second lens 308. Light exiting through the outcoupler 214 travels through the second lens 308 (which corresponds to, for example, the lens element 110 of the eyewear display 100). In use, the light exiting second lens 308 enters the pupil of an eye 216 of a user wearing the eyewear display 300, causing the user to perceive a displayed image carried by the display light output by the image source 202. In some embodiments, the optical combiner lens 304 is substantially transparent, such that light from real-world scenes corresponding to the environment around the eyewear display 300 passes through the first lens 306, the second lens 308, and the waveguide 210 to the eye 216 of the user. In this way, images or other graphical content output by the projection system 200 are combined (e.g., overlayed) with real-world images of the user's environment when projected onto the eye 216 of the user to provide an AR experience to the user. The eyebox 320 of eyewear display 300 corresponds to the region (or volume) in which the eye 216 of the user can perceive images associated with light projected from image source 202. In some embodiments additional optical elements are included in any of the optical paths between the image source 202 and the incoupler 212, in between the incoupler 212 and the outcoupler 214, and/or in between the outcoupler 214 and the eye 216 of the user (e.g., in order to shape the display light from image source 202 for viewing by the eye 216 of the user).

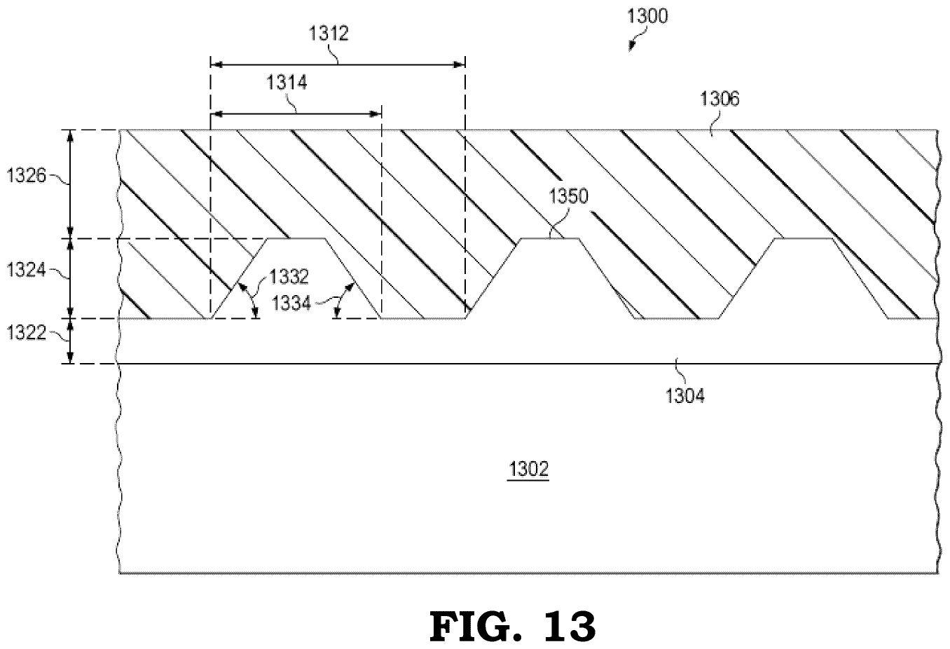

FIG. 4 shows a plan view 400 illustrating light propagation within the waveguide 210 of FIGS. 2 and 3 in accordance with some embodiments. As illustrated, the waveguide 210 includes the incoupler 212, an exit pupil expander 416, the outcoupler 214, and a recycler region 420. In some embodiments, each one of the incoupler 212, the exit pupil expander 416, the outcoupler 214, and the recycler region 420 include respective optical gratings (e.g., a diffractive grating) with grating features (e.g., the grating pitch, height/depth, angle, or the like as illustrated in FIG. 13) that are designed to direct light in the manners described herein.

In the illustrated embodiment of the waveguide 210, the incoupler 212 receives display light from the image source (not shown) and incouples the display light into the waveguide 210 as light beam 430 (one shown for clarity purposes) toward the exit pupil expander 416. The exit pupil expander 416 expands the light beam 430 along a first direction to generate multiple light beam copies 432-1, 432-2, 432-3 of the light beam 430. The exit pupil expander 416 directs the multiple light beam copies 432 toward the outcoupler 214, which expands each one of the multiple light beam copies 432 along a second direction that is different from the first direction and outcouples the light beams from the waveguide 210. For example, the outcoupler 214 receives the first light beam copy 432-1 from the exit pupil expander 416 and outcouples a plurality of outcoupled light beams 434 from the waveguide 210 including outcoupled light beam 434-1 and outcoupled light beam 434-2. Similarly, the outcoupler 214 receives the second light beam copy 432-2 from the exit pupil expander 416 and outcouples a plurality of outcoupled light beams 436 from the waveguide 210 including outcoupled light beam 436-1 and outcoupled light beam 436-2, and the outcoupler 214 receives the third light beam copy 432-3 from the exit pupil expander 416 and outcouples a plurality of outcoupled light beams 438 from the waveguide 210 including outcoupled light beam 438-1 and outcoupled light beam 438-2. In the illustrated embodiment, the second direction is illustrated as being out of the page (i.e., the outcoupler 214 outcouples the light beams from the waveguide 210 in the direction of the reader).

In some embodiments, the waveguide 210 also includes a recycler region 420. In some cases, not all of the light that is directed toward the outcoupler 214 from the exit pupil expander 416 is outcoupled from the waveguide 210. Thus, the recycler region 420 includes an optical grating that is configured to receive the light that makes it past the outcoupler 214 and direct this light back toward the outcoupler 214 so that it can be outcoupled from the waveguide 210. This increases the amount of light that is outcoupled from the waveguide 210, thereby improving quality of the virtual content delivered to the user.

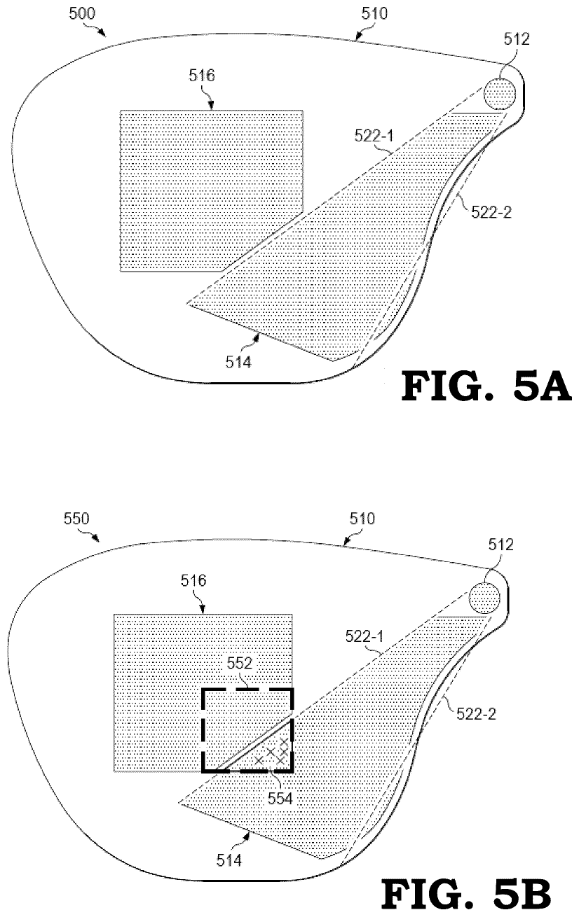

FIGS. 5A and 5B show a problem scenario associated with a conventional waveguide having an exit pupil expander that is allocated the maximum amount of space within the waveguide. That is, in FIGS. 5A and 5B, the exit pupil expander is allocated a maximum amount of space within the waveguide while the space allocated to the outcoupler is reduced. In the top diagram 500 of FIG. 5A, the waveguide 510 is shown with the incoupler 512, the exit pupil expander 514, and the outcoupler 516. The dashed lines 522-1, 522-2 represent the full extent of a rectangular FOV box as directed by the incoupler 512 toward the exit pupil expander 514. In other words, the incoupler 512 directs light toward the exit pupil expander 514 within the area outlined by the two dashed lines 522. Due to the size constraint imposed by the outline of the waveguide 510, the right side of the exit pupil expander 514 does not extend all the way to the dashed line 522-2 close to the incoupler 512, while on the left side of the exit pupil expander 514, the exit pupil expander 514 extends close to (if not all the way to) dashed line 522-1. However, by maximizing the area of the exit pupil expander 514 within the waveguide 510, a portion of the outcoupler 516 (i.e., the bottom right corner of the outcoupler 516 as illustrated in diagram 510) is truncated. This results in the problem illustrated in the bottom diagram 550 of FIG. 5B (which shows the same waveguide 510 shown in the top diagram 500). Referring to bottom diagram 550 of FIG. 5B, the dashed line rectangle 552 represents the projection of the FOV on the waveguide 510 from the user eyebox viewpoint. That is, the area within the dashed line rectangle 552 is the area of the waveguide 510 that is responsible for outcoupling light so that the user can observe the virtual content. However, due to the truncation of the outcoupler 516 as marked by the triangle 554 (i.e., since the area covered by the triangle 554 is allocated to the exit pupil expander 514 instead), the outcoupler feature from the area covered by triangle 554 is absent and no light is outcoupled to the user. Therefore, in the conventional waveguide shown in FIGS. 5A and 5B, the waveguide 510 cannot support the entire FOV corresponding to the dashed line rectangle 552.

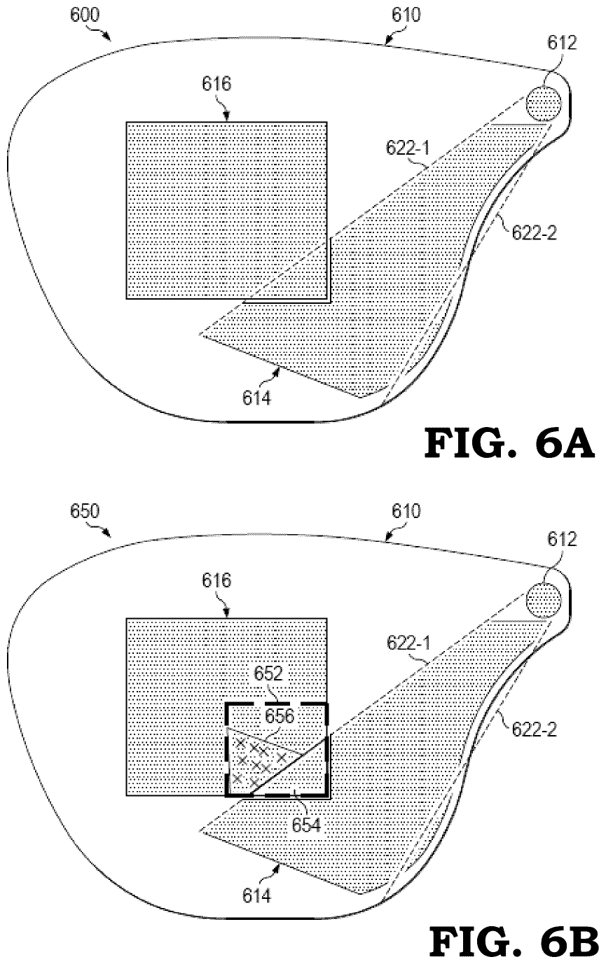

FIGS. 6A and 6B show a problem scenario associated with a conventional waveguide having an outcoupler that is allocated the maximum amount of space within the waveguide. That is, in FIGS. 6A and 6B, the outcoupler is allocated a maximum amount of space within the waveguide while the space allocated to the exit pupil expander is reduced. In the top diagram 600 of FIG. 6A, the waveguide 610 is shown with the incoupler 612, the exit pupil expander 614, and the outcoupler 616. The dashed lines 622-1, 622-2 represent the full extent of a rectangular FOV box as directed by the incoupler 612 toward the exit pupil expander 614. That is, similar to in FIGS. 5A and 5B, the incoupler 612 directs light toward the exit pupil expander 614 within the area marked by the two dashed lines 622. Due to the size constraint imposed by the outline of the waveguide 610, the right side of the exit pupil expander 614 does not extend all the way to the dashed line 622-2 near the incoupler 612, while on the left side of the exit pupil expander 614, a portion of the exit pupil expander 614 is cut out to make room to maximize the space occupied by the outcoupler 616. Thus, compared to the exit pupil expander 514 of FIGS. 5A and 5B, the exit pupil expander 614 occupies less space so as to make room for the bottom right corner of the outcoupler 616. In this sense, the exit pupil expander 614 has a “missing section” within the two dashed lines 622. This results in the problem illustrated in the bottom diagram 650 of FIG. 6B, which shows the same waveguide 610 as shown in the top diagram 600 of FIG. 6A. The dashed line rectangle 652 represents the projection of the FOV on the waveguide 610 from the user eyebox. The area within the dashed line rectangle 652 is the area that is intended to project display content to the user. However, due to the missing portion of the exit pupil expander 614 indicated by the triangle 654 (i.e., since the area of the triangle 654 is allocated to the outcoupler 616 instead), there is no light that is outcoupled to the user within the triangle 656 since this portion of the outcoupler 616 does not receive light from the exit pupil expander 614 due to the missing portion of the exit pupil expander 614 indicated by the triangle 654. Therefore, in the conventional waveguide shown in FIGS. 6A and 6B, the waveguide 610 cannot support the entire FOV corresponding to the dashed line rectangle 652.

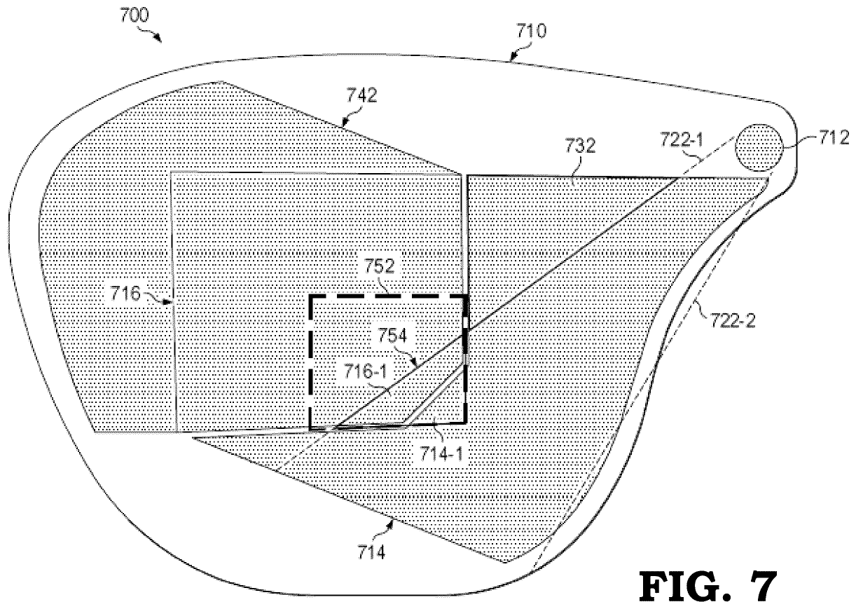

FIG. 7 shows a plan view 700 of a waveguide 710 in accordance with some embodiments. In some embodiments, the waveguide 710 corresponds to the waveguide of FIGS. 2-4. The waveguide 710 includes an incoupler 712, exit pupil expander 714, and an outcoupler 742. In addition, the waveguide 710 includes a hybrid outcoupler and exit pupil expander region 754. In some embodiments, the hybrid outcoupler and exit pupil expander region 754 increases the amount of light that is outcoupled to the user within the dashed line rectangle 752 (which represents the projection of the FOV on the waveguide 710 from the user eyebox) compared to the conventional waveguides shown in FIGS. 5 and 6. That is, the hybrid outcoupler and exit pupil expander region 754 of the waveguide 710 significantly reduces or eliminates the problems of conventional waveguides described in FIGS. 5A-B and FIGS. 6A-B above.

In the illustrated embodiment, the dashed lines 722-1, 722-2 represent the extent of the incoupled light beams, as directed by the incoupler 712, within the waveguide 710. For example, the incoupler 712 receives display slight beams from an image source (not picture) and incouples the display light beams into the waveguide 710 so that the light beams are propagated in the waveguide 710 within the area between the dashed liens 722-1, 722-2.

In some embodiments, the configuration of the hybrid outcoupler and exit pupil expander region 754 (e.g., the amount of space within the hybrid outcoupler and exit pupil expander region 754 allocated to the exit pupil expander 714 and outcoupler 714, respectively) is, at least in part, determined based on the size of the incoupler 712 and the area of the waveguide 716 that falls within the range of the light indicated by the dashed lines 722-1, 722-2. Additionally, in some embodiments, the configuration of the hybrid outcoupler and exit pupil expander region 754 is, at least in part, determined based on the exit pupil expander 714 and the outcoupler 716 being positioned on a same surface of the waveguide 710 (e.g., referring to FIG. 2, both the exit pupil expander 714 and the outcoupler 716 are positioned on major surface 220 or on major surface 222). In the illustrated embodiment of the hybrid outcoupler and exit pupil expander region 754, the outcoupler 716 has three sides that border the exit pupil expander 714.

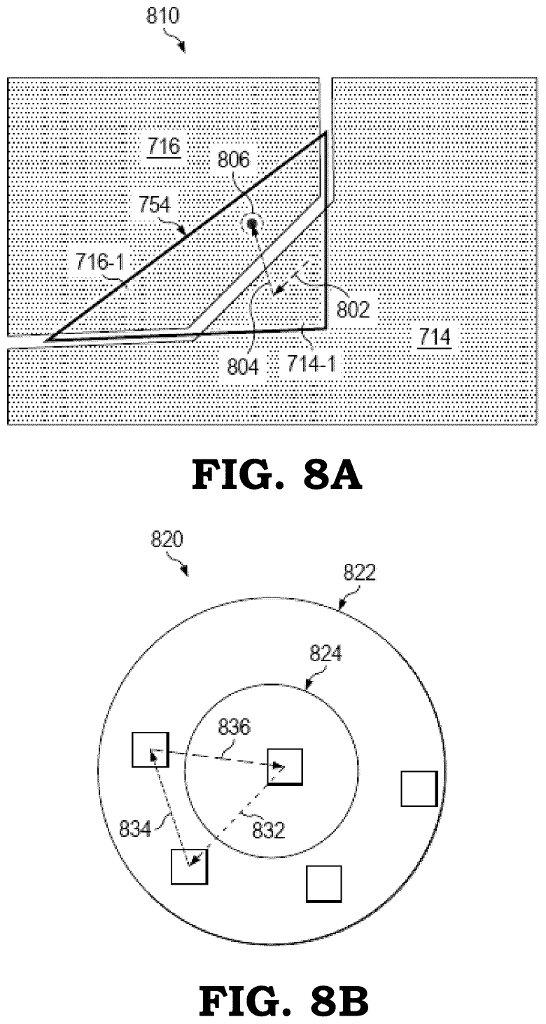

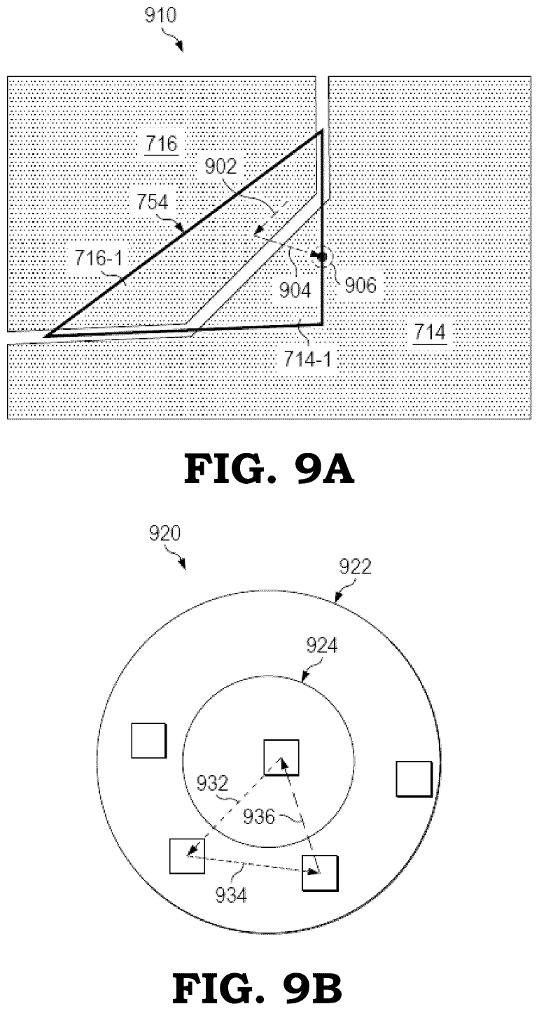

In the illustrated embodiment, the hybrid outcoupler and exit pupil expander region 754 includes an exit pupil expander section 714-1 belonging to the exit pupil expander 714 and an outcoupler section 716-1 belonging to the outcoupler 716. In other words, both the exit pupil expander 714 and the outcoupler 716 have respective sections (e.g., exit pupil expander section 714-1 and outcoupler section 716-1) that fall within the hybrid outcoupler and exit pupil expander region 754. In addition, in some embodiments, both the exit pupil expander 714 and the outcoupler 716 include respective sections that fall outside the hybrid outcoupler and exit pupil expander region 754. For example, for the exit pupil expander 714, this includes any section of the exit pupil expander 714 that is not included in the triangular exit pupil expander section 714-1, and for the outcoupler 716, this includes any section of the outcoupler 716 that is not included in the trapezoidal outcoupler section 716-1. The section of the exit pupil expander 714 that falls outside the hybrid outcoupler and exit pupil expander region 754 receives light from the incoupler 712 and directs the light to the outcoupler 716 but the section of the exit pupil expander 714 that falls outside the hybrid outcoupler and exit pupil expander region 754 does not receive light from the outcoupler 716 for outcoupling from the waveguide 714. The section of the outcoupler 716 that falls outside the hybrid outcoupler and exit pupil expander region 754 receives the light from the exit pupil expander 714 and outcouples the light from the waveguide 710 but the section of the outcoupler 716 that falls outside the hybrid outcoupler and exit pupil expander region 754 does not directly receive light from the incoupler and direct it to the exit pupil expander 714. In some embodiments, at least one side of the hybrid outcoupler and exit pupil expander region 754 is defined by the dashed line 722-1 that corresponds to the space of the waveguide 710 within which light is incoupled by the incoupler 712. The waveguide 710 with the hybrid outcoupler and exit pupil expander region 754 is able to support the entire FOV corresponding to the dashed line rectangle 752. That is, unlike the conventional waveguides shown in FIGS. 5 and 6, the waveguide 710 with the hybrid outcoupler and exit pupil expander region 754 illustrated in FIG. 7 reduces or eliminates the areas of the waveguide that do not outcouple display light to the user. FIGS. 8 and 9 illustrate the operational aspects of the hybrid outcoupler and exit pupil expander region 754 in additional detail.

First, referring to FIGS. 8A and 8B, a first operational aspect of the hybrid outcoupler and exit pupil expander region 754 of waveguide 710 of FIG. 7 is shown in a close up view 810 of FIG. 8A. FIG. 8B shows a k-space vector diagram 820 corresponding to FIG. 8A and illustrates how the FOV is manipulated by different elements for a particular source center wavelength. In the illustrated embodiment of the k-space vector diagram 820 (and the other k-space diagrams in the other figures), each rectangular box represents an approximately 30° diagonal FOV associated with the waveguide 710. Other embodiments include other values for the diagonal FOV (i.e., values other than 30°). Also, in the illustrated embodiment of the k-space vector diagram 820 (and the other k-space diagrams in the other figures), the outer circle 822 represents the waveguide substrate refractive index, which is approximately 2.0 in the illustrated embodiment, and the inner circle 824 represents the refractive index of air (e.g., approximately 1.0).

In the close up view 810 of FIG. 8A, the first arrow 802 represents an incoupled beam of light traveling through the exit pupil expander 714 after being directed to the exit pupil expander 714 by the incoupler (not shown). The incoupled beam of light is redirected by the exit pupil expander section 714-1 towards the outcoupler 716. This redirected light beam is represented by the second arrow 804. The redirected light beam 804 is outcoupled from the waveguide by the outcoupler section 716-1. The outcoupled light beam is represented by a circle with a dot in the center 806 which represents an arrow that is going out of the page. As such, close up view 810 of FIG. 8A illustrates a first operational aspect of the hybrid outcoupler and exit pupil expander region 754 with the exit pupil expander section 714-1 and the outcoupler section 716-1. The k-space operation of this first operational aspect is shown in the k-space vector diagram 820 of FIG. 8B. In the k-space vector diagram 820, the first arrow 832 represents the k-space incoupler vector which corresponds to the first arrow 802 of close up view 810, the second arrow 834 represents the k-space exit pupil expander vector which corresponds to the second arrow 804 of close up view 810, and the third arrow 836 represents the k-space outcoupler vector which corresponds to the third arrow 806 (i.e., the arrow that is going out of the page) of close up view 810. As illustrated, the k-space vector diagram 820 shows that the k-space vector loop is “closed,” which indicates that the outcoupled display light beam is outcoupled toward the user within the target eyebox.

Now referring to FIGS. 9A and 9B, a second operational aspect of the hybrid outcoupler and exit pupil expander region 754 of waveguide 710 of FIG. 7 is shown in a close up view 910 of FIG. 9A. FIG. 9B shows a k-space vector diagram 920 corresponding to FIG. 9A and illustrates how the FOV is manipulated by different elements for a particular source center wavelength. In the illustrated embodiment of the k-space vector diagram 920 (and the other k-space diagrams in the other figures), each rectangular box represents an approximately 30° diagonal FOV associated with the waveguide 710. Other embodiments include other values for the diagonal FOV (i.e., values other than 30°). Also, in the illustrated embodiment of the k-space vector diagram 920 (and the other k-space diagrams in the other figures), the outer circle 922 represents the waveguide substrate refractive index, which is approximately 2.0 in the illustrated embodiment, and the inner circle 924 represents the refractive index of air (e.g., approximately 1.0).

In the close up view 910 of FIG. 9A, the first arrow 902 represents an incoupled beam of light traveling through the outcoupler 716 after being directed to the outcoupler 716 by the incoupler (not shown). The incoupled beam of light is redirected by the outcoupler section 716-1 towards the exit pupil expander 714. This redirected light beam from the outcoupler section 716-1 is represented by the second arrow 904. The redirected light beam 904 is outcoupled from the waveguide by the exit pupil expander section 714-1. That is, in the second operational aspect of the hybrid outcoupler and exit pupil expander region 754, the outcoupler section 716-1 and the exit pupil expander section 714-1 reverse roles as described above in FIGS. 8A and 8B which explains the first operational aspect of the hybrid outcoupler and exit pupil expander region 754. The outcoupled light beam is represented by a circle with a dot in the center 906 which represents an arrow that is going out of the page. In this manner, close up view 910 illustrates the second operational aspect of the hybrid outcoupler and exit pupil expander region 754 with the exit pupil expander section 714-1 and the outcoupler section 716-1. The k-space operation of this second operational aspect is shown in the k-space vector diagram 920 of FIG. 9B. In the k-space vector diagram 920, the first arrow 932 represents the k-space incoupler vector which corresponds to the first arrow 902 of close up view 910, the second arrow 934 represents the k-space outcoupler vector which corresponds to the second arrow 904 of close up view 910, and the third arrow 936 represents the k-space exit pupil expander vector which corresponds to the third arrow 906 (i.e., the arrow that is going out of the page) of close up view 910. As illustrated, the k-space vector diagram 920 shows that the k-space vector loop is “closed,” which indicates that the outcoupled display light beam is outcoupled toward the user within the target eyebox. In addition, for the second operational aspect illustrated in FIGS. 9A and 9B, the outcoupler section 716-1 operates as the exit pupil expander role and the exit pupil expander section 714-1 operates as the outcoupler for the illustrated light beams.

Thus, the hybrid outcoupler and exit pupil expander region 754 includes a section of the exit pupil expander 714 and a section of the outcoupler 716. The exit pupil expander section (e.g., exit pupil expander section 714-1) of the hybrid outcoupler and exit pupil expander region 754 receives a first portion of the incoupled light beams (e.g., corresponding to the first arrow 802 of FIG. 8A) and redirects the first portion of the incoupled light beams to the outcoupler section (e.g., outcoupler section 716-1) of the hybrid outcoupler and exit pupil expander region 754 as the redirected first portion of the incoupled light beams (e.g., corresponding to the second arrow 804 of FIG. 8A). Similarly, the outcoupler section (e.g., outcoupler section 716-1) of the hybrid outcoupler and exit pupil expander region 754 receives a second portion of the incoupled light beams (e.g., corresponding to the first arrow 902 of FIG. 9A) and redirects the second portion of the incoupled light beams to the exit pupil expander section (e.g., exit pupil expander section 714-1) of the hybrid outcoupler and exit pupil expander region 754 as the redirected second portion of the incoupled light beams (e.g., corresponding to the second arrow 904 of FIG. 9A). In addition, each one of the exit pupil expander section (e.g., exit pupil expander section 714-1) and the outcoupler section (e.g., outcoupler section 716-1) of the hybrid outcoupler and exit pupil expander region 754 then outcouple the light beams received from the other respective section. In this manner, the waveguide 710 with the hybrid outcoupler and exit pupil expander region 754 supports the outcoupling of light over the entire FOV represented by the dashed line rectangle 752 of FIG. 7.

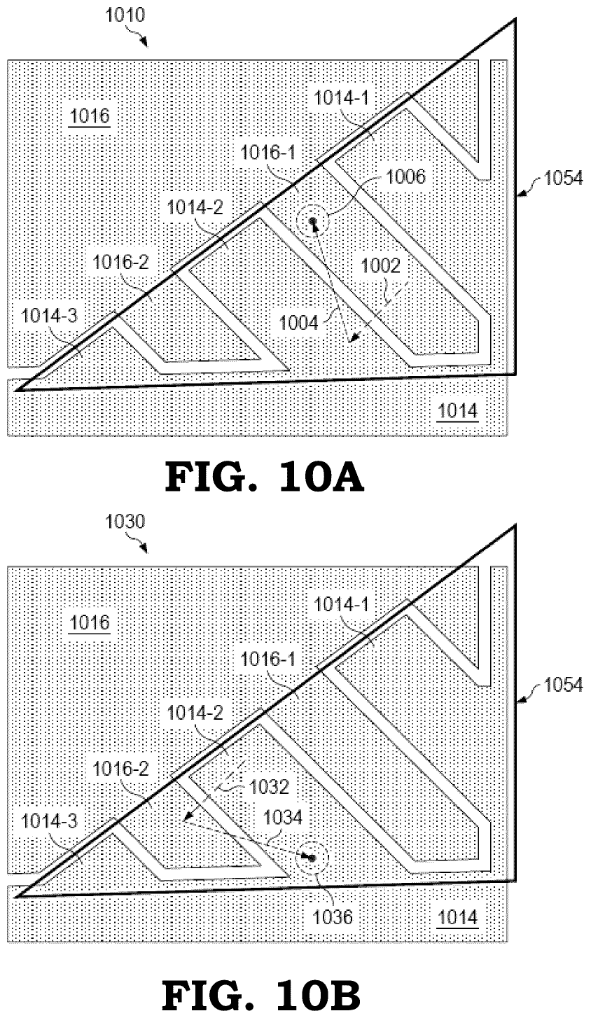

In some embodiments, the size and shape of the exit pupil expander 714 and the outcoupler 716 and the border between the two (collectively referred to as “waveguide with a hybrid outcoupler and exit pupil expander configuration”) are designed based on one or more performance considerations. That is, in some embodiments, the waveguide with a hybrid outcoupler and exit pupil expander configuration is designed to optimize the output image quality within a target user eyebox volume. For example, FIGS. 10A and 10B show an example of a waveguide with a hybrid outcoupler and exit pupil expander configuration with interlaced regions in accordance with some embodiments.

FIGS. 10A,10B show close up views 1010, 1030, respectively, of an example of a waveguide (such one corresponding to the waveguide shown in any of FIGS. 2-4 and 7) with a hybrid outcoupler and exit pupil expander configuration having interlaced regions 1054 in accordance with some embodiments. In the illustrated embodiment in FIGS. 10A and 10B, the waveguide includes an exit pupil expander 1014 with regions 1014-1, 1014-2, 1014-3 that are interlaced with regions 1016-1, 1016-2 of the outcoupler 1016. In some embodiments, the size (e.g., the width) of the exit pupil expander regions 1014-1, 1014-2, 1014-3 and the outcoupler regions 1016-1, 1016-2 are constrained by the dimension of the incoupler. For example, the width of each of the exit pupil expander regions 1014-1, 1014-2, 1014-3 and of the outcoupler regions 1016-1, 1016-2 is a fraction (i.e., less than) of the incoupler diameter to ensure that there is enough pupil replication across the target eyebox.

In the illustrated embodiment, the hybrid outcoupler and exit pupil expander configuration having interlaced regions 1054 functions according to two operational aspects similar to those described above with respect to FIGS. 8A,8B and FIGS. 9A, 9B. That is, close up view 1010 of FIG. 10A illustrates a first operational aspect of the hybrid outcoupler and exit pupil expander configuration having interlaced regions 1054. In close up view 1010, the first arrow 1002 represents an incoupled beam of light traveling through to the exit pupil expander 1014 after being directed to the exit pupil expander 1014 by the incoupler (not shown). The incoupled beam of light is redirected by the exit pupil expander region 1014-2 towards the outcoupler 1016. This redirected light beam is represented by the second arrow 1004. The redirected light beam 1004 is outcoupled from the waveguide by the outcoupler region 1016-1. The outcoupled light beam is represented by a circle with a dot in the center 1006 which represents an arrow that is going out of the page. In this manner, close up view 1010 illustrates a first operational aspect of the hybrid outcoupler and exit pupil expander configuration having interlaced regions 1054.

Referring now to close up view 1030 of FIG. 10B representing the same hybrid outcoupler and exit pupil expander configuration having interlaced regions 1054 shown in close up view 1010 of FIG. 10A, the first arrow 1032 represents an incoupled beam of light traveling through to the outcoupler 1016 after being directed to the outcoupler 1016 by the incoupler (not shown). The incoupled beam of light is redirected by the outcoupler region 1016-2 towards the exit pupil expander 1014. This redirected light beam is represented by the second arrow 1034. The redirected light beam 1034 is outcoupled from the waveguide by the exit pupil region 1014-2. The outcoupled light beam is represented by a circle with a dot in the center 1036 which represents an arrow that is going out of the page. As such, close up view 1030 illustrates a second operational aspect of the hybrid outcoupler and exit pupil expander configuration having interlaced regions 1054. In some embodiments, the hybrid outcoupler and exit pupil expander configuration having interlaced regions 1054 exhibits greater tolerance to the size of the incoupler as compared to the embodiment without the interlaced regions shown and described in FIGS. 8A,8B and FIGS. 9A, 9B.

Referring back to FIG. 7, in some embodiments, the waveguide 710 includes an exit pupil expander 714 with one or more extended exit pupil expander zones 732. That is, compared to the conventional waveguides illustrated in FIGS. 5 and 6, the exit pupil expander 714 includes the additional exit pupil expander zone 732 that expands the space within the waveguide 710 that is occupied by the exit pupil expander 714. In the illustrated embodiment, the additional exit pupil expander zone 732 extends the exit pupil expander to border the right side of the outcoupler 716. In some embodiments, by extending the exit pupil expander 714 to include the exit pupil expander zone 732, the waveguide 710 produces an output image with an improved color uniformity, especially in cases in which the waveguide 710 operates to deliver images with multiple colors. This is attributed to the additional exit pupil expander zone 732 providing for additional spreading of TIR light within the waveguide 710 by increasing the interactions of the light with the exit pupil expander grating.

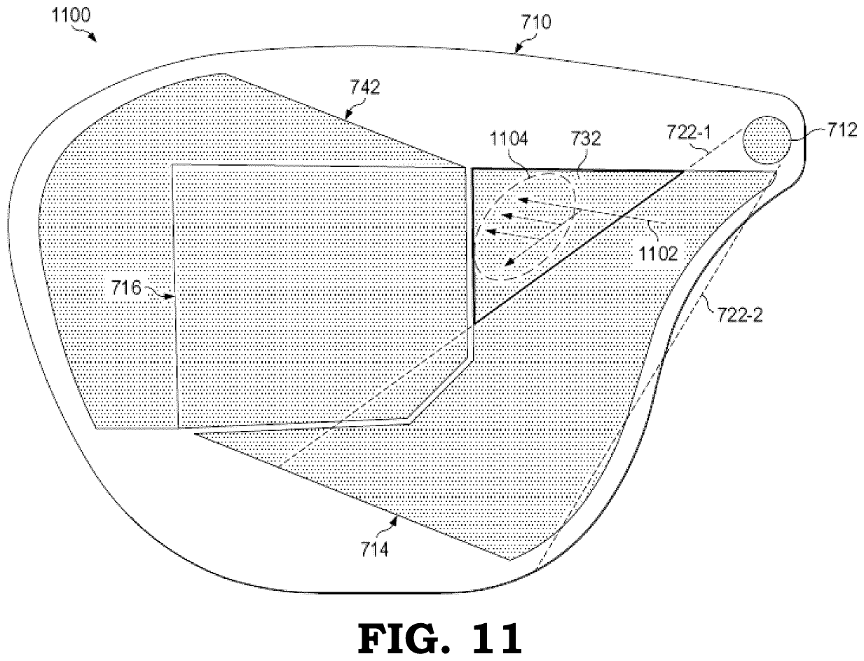

FIG. 11 illustrates an example 1100 of the additional exit pupil expander zone 732 of the exit pupil expander 714 providing the additional spreading 1104 of a single light beam 1102 prior to the light reaching the outcoupler 716 in accordance with some embodiments. In the illustrated embodiment, the additional exit pupil expander zone 732 provides for additional spreading of the light beam 1102 into multiple light beams 1104. This improves the color uniformity of the output image that is provided by the waveguide 710 to the user.

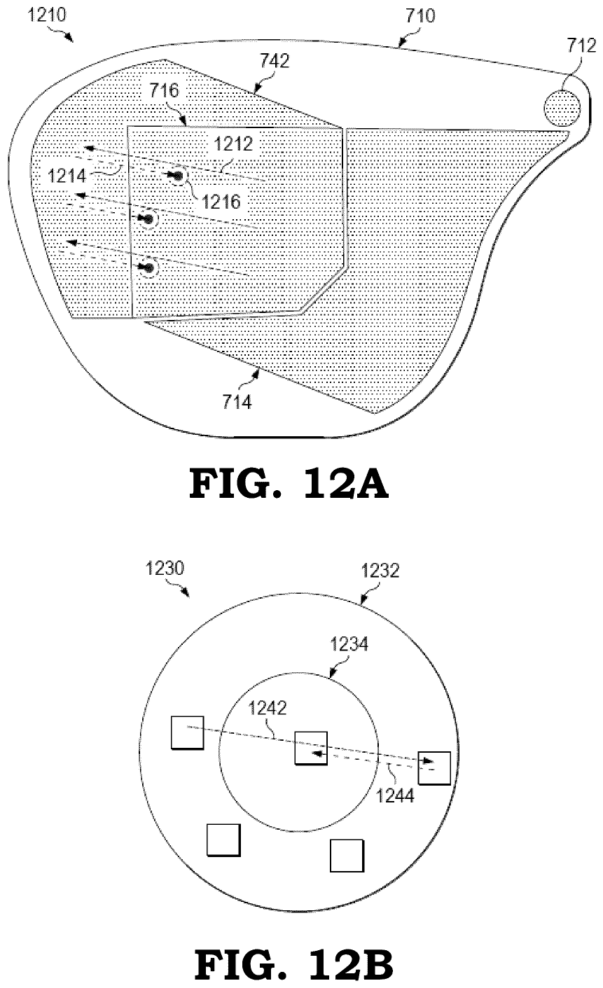

Referring back to FIG. 7, in some embodiments, the waveguide 710 includes a recycler region 742 as a third feature (with the first feature being the hybrid outcoupler and exit pupil expander region described in FIGS. 7-10 and the second feature being the extended exit pupil expander zone described in FIG. 11) to improve the performance of the waveguide 710. The recycler region 742 is illustrated in further detail in FIG. 12.

FIGS. 12A and 12B show a plan view 1210 of the waveguide 710 of FIG. 7 illustrating the interaction of light with the recycler region 742 and a corresponding k-space diagram 1230 in accordance with some embodiments.

First, referring to FIG. 12A, in some embodiments, the grating pitch (illustrated, for example, in FIG. 13) of the grating in the recycler region 742 is half that of the grating pitch of the grating in the outcoupler 716. In addition, in some embodiments, the orientation angle of the grating in the recycler region 742 is the same or substantially similar (e.g., within a margin of about 5%) as the orientation angle of the grating in the outcoupler 716. The first series of arrows 1212 (one labeled for clarity purposes) from the outcoupler 716 to the recycler region 742 represents the TIR light that passes through the outcoupler 716 (i.e., this light is not outcoupled by the outcoupler 716). The second series of arrows 1214 (one labeled for clarity purposes) from the recycler region 742 to the outcoupler 716 represents the TIR light that is redirected by the recycler region 742 back to the outcoupler 716. That is, the second series of arrows 1214 represents the “recycled” TIR light that initially passes through the outcoupler 716 and is redirected back to the outcoupler 716. This “recycled” light is then outcoupled by the outcoupler 716. The recycled outcoupled light is represented by the circle with a dot in the center 1216 (one labeled for clarity) which represents an arrow that is going out of the page.

The k-space diagram 1230 of FIG. 12B corresponds to FIG. 12A and shows how the recycler region 742 manipulates the light. In the illustrated embodiment of the k-space vector diagram 1230 (and the other k-space diagrams in the other figures), each rectangular box represents an approximately 30° diagonal FOV associated with the waveguide 710. Also, in the illustrated embodiment of the k-space vector diagram 1230, the outer circle 1232 represents the waveguide substrate refractive index, which is approximately 2.0 in the illustrated embodiment, and the inner circle 1234 represents the refractive index of air (e.g., approximately 1.0). In the k-space vector diagram 1230, the first arrow 12422 represents the k-space recycler vector which corresponds to the second arrow 1214 of plan view 1210, and the second arrow 1244 represents the k-space outcoupler vector which corresponds to the circle with a dot in the center 1216 of plan view 1210. As illustrated in the k-space diagram 1230, the recycler region 742 closes the k-space vector loop by returning the k-space vector to the center of the k-space diagram, indicating that the light is outcoupled by the outcoupler 716 back into the air toward the user eyebox. In this manner, the recycler region 742 recycles at least some of the light that is otherwise lost via the outer edge of the waveguide 710. This improves the overall efficiency of the waveguide 710. In addition, since different light colors may propagate and get recycled differently within the waveguide 710, the recycler region 742 provides greater design freedom to optimize the color uniformity of the display from the waveguide 710.

FIG. 13 shows an example cross-section view of a portion of a surface relief grating structure 1300 that can be implemented as the optical grating at one or more of the incoupler, the exit pupil expander, the outcoupler, and the recycler region in accordance with some embodiments. In the illustrated embodiment, the components associated with the surface relief grating structure 1300 include one or more of the waveguide substrate 1302, the grating material 1304, and the encapsulation material 1306. The surface relief grating structure 1300 includes a plurality of surface relief grating protrusions 1350 (one labeled for clarity) composed of the grating material 1304. In addition, FIG. 13 illustrates various geometric features associated with the surface relief grating 1300.

The surface relief grating structure 1300 includes a grating pitch 1312 (also referred to as the grating period, and denoted as A_{G}, in short) between adjacent ones of the surface relief grating protrusions 1350. In addition, the surface relief grating structure 1300 includes a portion 1314 of the grating pitch that contains one of the surface relief grating protrusions 1350 (this portion 1314 is denoted as A_{F}, in short). In some embodiments, the grating pitch (A_{G}) 1312 for the incoupler, exit pupil expander, and the outcoupler is in the range of about 300 nanometers (nm) to about 500 nm, and the grating pitch (A_{G}) 1312 is about 150 nm to about 250 nm for the recycler region. In some embodiments, the grating pitch 1312 of the recycler region is half that of the grating pitch of the outcoupler. The ratio of portion of the grating pitch that contains the surface relief grating 1314 to the ratio of the grating pitch 1312 (i.e., the ratio A_{F}/A_{G}) is the grating fill factor and can fall between 0 and 1.

In the illustrated embodiment, the surface relief grating structure 1300 is shown as being composed of a two materials (i.e., the encapsulation material 1306 and the grating material 1304) on top of the waveguide substrate 1302. In other embodiments, a different number of materials (e.g., more than two) are included. In some embodiments, the surface relief grating structure 1300 is fabricated via nanoimprint lithography, pattern transfer techniques, direct etching techniques, or the like. In addition to include the plurality of surface relief grating protrusions 1350, in some embodiments, the surface relief grating structure 1300 includes a grating material layer having a first thickness 1322 between the plurality of surface relief grating protrusions 1350 and the waveguide substrate 1302. For example, in some embodiments, the first thickness 1322 is in the range of about 10 to 300 nm.

In some embodiments, the grating material 1304 is an organic or inorganic grating material whose refractive index is in the range of about 1.5 to 2.5. In some embodiments, the encapsulation material 1306 is an organic or inorganic grating material whose refractive index is in the range of about 1.5 to 2.5. In some embodiments, the grating material 1304 and the encapsulation material 1306 are the same material, and in other embodiments, the grating material 1304 and the encapsulation material 1306 are different materials. For example, in some embodiments, the grating material can be a metallic material such as aluminum, silver, another metal, or an alloy. In some embodiments, the height 1324 of the plurality of surface relief grating protrusions 1350 is in the range of about 10 to 300 nm. In some embodiments, the depth 1326 of the encapsulation material above the plurality of surface relief grating protrusions 1350 is about 10 to 300 nm. In some embodiments, each of the plurality of surface relief grating protrusions 1350 is defined by one or more angles. For example, in the illustrated embodiment, each one of the plurality of surface relief grating protrusions 1350 is defined by a first angle 1332 and a second angle 1334. In some embodiments, the first angle 1332 and the second angle 1334 range between 0° and 180°. For example, the first angle 1332 is between about 30° and 90° and the second angle 1334 is between about 30° and 90°. In some embodiments, one or more of the aforementioned parameters (e.g., the grating pitch (A_{G}) 1312, the portion of grating pitch (A_{F}) 1314, the first thickness 1322, the height 1324, the depth 1326, the first angle 1332, and the second angle 1334) are variable across the surface area within each one of the incoupler, the exit pupil expander, the outcoupler, or the recycler region. That is, in some embodiments, each one of the incoupler, the exit pupil expander, the outcoupler, and the recycler region include different dimensions for one or more of the aforementioned features.

In some embodiments, the variation of the thickness, height, or depths of the layers shown in FIG. 13 are controlled along with the total waveguide substrate thickness to control the impact of coherent artifacts from the overall waveguide architecture. For example, in some cases, a Total Thickness Variation (TTV) spec is applied to the entire substrate area and is within hundreds of nanometers across an active area of the waveguide. In addition, in some embodiments, the regions of the waveguide that do not contain the diffractive structures (i.e., regions of the waveguide surface that do not contain the incoupler, the exit pupil expander, the outcoupler, and the recycler region) contain an anti-reflective coating to maintain high transparency through the waveguide.

In some embodiments, each one of the gratings included in the incoupler, the exit pupil expander, the outcoupler, and the recycler region have corresponding grating orientations within the waveguide. The grating orientation defines the direction in which light is directed by each of the respective optical components of the waveguide. For example, in some embodiments, the grating orientation of the exit pupil expander grating is designed to receive incoupled light from the incoupler, expand the light along one direction, and propagate the light toward the outcoupler. In another example, the grating orientation of the outcoupler grating is different than that of the grating orientation of the exit pupil expander grating and is configured to receive the light from the exit pupil expander and outcouple the light from the waveguide. In addition, in some embodiments, the grating orientation of the exit pupil expander grating in the hybrid outcoupler and exit pupil expander region is additionally designed to outcouple light received from the outcoupler and the grating orientation of the outcoupler grating in the hybrid outcoupler and exit pupil expander region is additionally designed to receive incoupled light from the incoupler and direct it to the exit pupil expander.

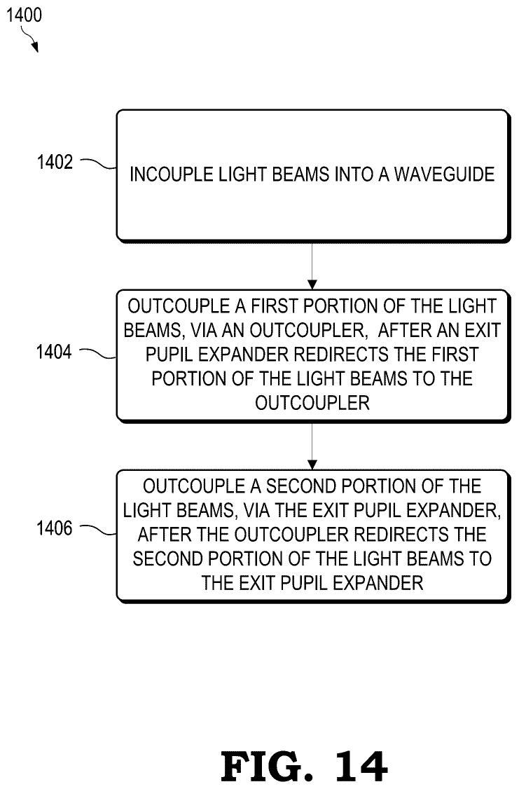

FIG. 14 shows a flowchart 1400 illustrating a method for outcoupling light from a waveguide, such as any one of the waveguides of FIGS. 2-4 and 5-12, in accordance with some embodiments.

At block 1402, the method includes incoupling, by an incoupler, light beams into the waveguide. At block 1404, the method includes outcoupling, by an outcoupler of the waveguide, a first portion of the light beams from the waveguide after the first portion of the light beams are redirected to the outcoupler by an exit pupil expander. At block 1406, the method includes outcoupling, by the exit pupil expander, a second portion of the light beams from the waveguide after the second portion of the light beams are redirected to the exit pupil expander by the outcoupler.

Note that not all of the activities or elements described above in the general description are required, that a portion of a specific activity or device may not be required, and that one or more further activities may be performed, or elements included, in addition to those described. Still further, the order in which activities is listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide comprising:
an incoupler to incouple light beams into the waveguide; and
an exit pupil expander to receive a first portion of the incoupled light beams and redirect the first portion of the incoupled light beams to an outcoupler of the waveguide,
wherein the outcoupler receives a second portion of the incoupled light beams and redirects the second portion of the incoupled light beams to the exit pupil expander, wherein the exit pupil expander receives the redirected second portion of the incoupled light beams and outcouples the redirected second portion of the incoupled light beams from the waveguide.

2. The waveguide of claim 1, wherein the exit pupil expander and the outcoupler share a border along three sides of the outcoupler.

3. The waveguide of claim 1, wherein the outcoupler comprises a first outcoupler section to receive the redirected first portion of the incoupled light beams and outcouple the redirected first portion of the incoupled light beams from the waveguide, wherein the first outcoupler section receives the second portion of the incoupled light beams and redirects the second portion of the incoupled light beams to the exit pupil expander.

4. The waveguide of claim 3, wherein the exit pupil expander comprises a first exit pupil expander section to receive the redirected second portion of the incoupled light beams and outcouple the redirected second portion of the incoupled light beams from the waveguide, wherein the first exit pupil expander section receives the first portion of the incoupled light beams and redirects the first portion of the incoupled light beams to the outcoupler.

5. The waveguide of claim 4, wherein the outcoupler comprises a second outcoupler section that does not receive the second portion of the incoupled light beams and the exit pupil expander comprises a second exit pupil expander section that does not receive the redirected second portion of the incoupled light beams.

6. The waveguide of claim 1, wherein the incoupler, exit pupil expander, and the outcoupler are applied on a same major surface of the waveguide.

7. The waveguide of claim 1, wherein the outcoupler comprises a plurality of outcoupler regions that are interlaced with a plurality of exit pupil expander regions of the exit pupil expander.

8. The waveguide of claim 7, where a width of each of the plurality of outcoupler regions and of the plurality of exit pupil expander regions is a fraction of a diameter or width of the incoupler.

9. The waveguide of claim 1, the exit pupil expander comprising at least one extended exit pupil expander zone that conformally borders at least one side of the outcoupler.

10. The waveguide of claim 9, wherein the at least one side of the outcoupler is a side of the outcoupler closest to the incoupler.

11. The waveguide of claim 1, further comprising a recycler region arranged on an opposite side of the outcoupler as the exit pupil expander.

12. The waveguide of claim 11, wherein a grating pitch of a recycler grating in the recycler region is one half of a grating pitch of an outcoupler grating in the outcoupler.

13. The waveguide of claim 11, wherein the recycler region is configured to redirect light that passes through the outcoupler back toward the outcoupler.

14. An eyewear display comprising:
a projector configured to emit light beams; and
a waveguide incorporated into a lens of the eyewear display, the waveguide comprising:
an incoupler to incouple the light beams into the waveguide; and
an exit pupil expander to receive a first portion of the incoupled light beams and redirect the first portion of the incoupled light beams to an outcoupler of the waveguide,
wherein the outcoupler receives a second portion of the incoupled light beams and redirects the second portion of the incoupled light beams to the exit pupil expander, wherein the exit pupil expander receives the redirected second portion of the incoupled light beams and outcouples the redirected second portion of the incoupled light beams from the waveguide.

15. The eyewear display of claim 14, wherein the outcoupler comprises a first outcoupler section to receive the redirected first portion of the incoupled light beams and outcouple the redirected first portion of the incoupled light beams from the waveguide, wherein the first outcoupler section receives the second portion of the incoupled light beams and redirects the second portion of the incoupled light beams to the exit pupil expander.

16. The eyewear display of claim 15, wherein the exit pupil expander comprises a first exit pupil expander section to receive the redirected second portion of the incoupled light beams and outcouple the redirected second portion of the incoupled light beams from the waveguide, wherein the first exit pupil expander section receives the first portion of the incoupled light beams and redirects the first portion of the incoupled light beams to the outcoupler.

17. The eyewear display of claim 14, wherein the outcoupler comprises a plurality of outcoupler regions that are interlaced with a plurality of exit pupil expander regions of the exit pupil expander.

18. The eyewear display of claim 14, the waveguide further comprising:
a recycler region arranged on an opposite side of the outcoupler as the exit pupil expander.

19. A method comprising:
incoupling, by an incoupler, light beams into a waveguide;
outcoupling, by an outcoupler, a first portion of the light beams from the waveguide after the first portion of the light beams are redirected to the outcoupler by an exit pupil expander; and
outcoupling, by the exit pupil expander, a second portion of the light beams from the waveguide after the second portion of the light beams are redirected to the exit pupil expander by the outcoupler.

20. The method of claim 19, further comprising:
redirecting, by a recycler region positioned on an opposite side of the outcoupler as the exit pupil expander, a third portion of the light beams back toward the outcoupler so that at least a fraction of the third portion of light beams are outcoupled of the waveguide by the outcoupler.
